(19) United States
(12) Patent Application Publication
(10) Pub. No.: US 2026/0100617 A1
(43) Pub. Date: Apr. 9, 2026

(54) ROTOR ASSEMBLY WITH ROD FOR ELECTRIC MACHINE

(71) Applicant: FCA US LLC, Auburn Hills, MI (US)

(72) Inventors: Reemon Haddad, Auburn Hills, MI (US); Dhafar Al-Ani, Auburn Hills, MI (US)

(21) Appl. No.: 18/908,915

(22) Filed: Oct. 8, 2024

(51) Int. Cl. H02K 1/28; H02K 1/276

(52) U.S. Cl. CPC H02K 1/28; H02K 1/276

(57) ABSTRACT

An electric machine for powering an electric vehicle includes a rotor assembly configured to rotate relative to a stator to drive a rotor shaft and at least one drive wheel of the electric vehicle. The rotor assembly comprises a rotor stack, a rotor shaft, a first end plate, a second end plate and a rod assembly. The first end plate is arranged at a first end of the rotor stack. The second end plate is arranged at a second end of the rotor stack. The rod assembly includes a plurality of rods integrally formed with the first end plate. The plurality of rods extend through passages in the rotor stack and through a plurality of complementary passages defined in the second end plate.

### FIELD

The present application relates generally to electric machines and more particularly to a rotor assembly having an improved rod configuration.

### BACKGROUND

Different types of electric vehicles, including mild hybrid electric vehicles (mHEV's), plug-in hybrid electric vehicles (PHEV's), battery electric vehicles (BEV's), and range extended battery electric vehicles (REEV's), rely on electric machines for propulsion as a main source of torque, which generates the necessary power for vehicle propulsion. Electric machines with tie-rods in the rotor assembly are commonly used in high-speed, high-power applications. Tie-rods are typically steel rods that are threaded and pass through complementary holes in the rotor structure and secured with nuts and washers. The tie-rods provide may benefits to the rotor assembly including: structural integrity, reduced stresses and simplified assembly and maintenance process. Tie-rods however can introduce additional complexity and potential points of failure in the rotor structure. In this regard, while existing tie-rod rotor configurations can be satisfactory, there remains a need for improvement in the relevant art.

### SUMMARY

In accordance with one example aspect of the invention, an electric machine for powering an electric vehicle includes a rotor assembly configured to rotate relative to a stator to drive a rotor shaft and at least one drive wheel of the electric vehicle. The rotor assembly comprises a rotor stack, a rotor shaft, a first end plate, a second end plate and a rod assembly. The first end plate is arranged at a first end of the rotor stack. The second end plate is arranged at a second end of the rotor stack. The rod assembly includes a plurality of rods integrally formed with the first end plate. The plurality of rods extend through passages in the rotor stack and through a plurality of complementary passages defined in the second end plate.

In examples, rods of the plurality of rods each define notches at distal ends that locate at the plurality of complementary passages in the second end plate.

In examples, the plurality of rods are pressed into the plurality of complementary passages in the second end plate.

In other examples, the first end plate and the rod assembly are formed of a common material.

In other implementations, the passages of the plurality of complementary passages defined in the second end plate define elongated holes.

In examples, the respective notches of the plurality of rods locate at the elongated holes.

In additional arrangements, an electric machine for powering an electric vehicle includes a rotor assembly configured to rotate relative to a stator to drive a rotor shaft and at least one drive wheel of the electric vehicle. The rotor assembly comprises a rotor stack, a rotor shaft, a first end plate, a second end plate and a rod assembly. The first end plate is arranged at a first end of the rotor stack and defines a plurality of first passages. The second end plate is arranged at a second end of the rotor stack and defines a plurality of second passages. The rod assembly includes a plurality of rods extending through passages in the rotor stack and having first ends extending through a plurality of first complementary passages defined in the first end plate and second ends extending through a plurality of second complementary passages defined in the second end plate.

In other examples, rods of the plurality of rods each define first notches at first distal ends that locate at the plurality of first passages in the first end plate.

In additional implementations, rods of the plurality of rods each define second notches at second distal ends that locate at the plurality of second passages in the second end plate.

In examples the plurality of rods are pressed into the plurality of first passages in the first end plate.

In other examples the plurality of rods are pressed into the plurality of second passages in the second end plate.

In additional examples the first end plate and the rod assembly are formed of a distinct materials.

In other examples of the method, the passages of the plurality of complementary passages defined in the first end plate define one of circular or elongated holes.

In additional examples, the passages of the plurality of complementary passages defined in the first end plate define elongated holes.

In additional implementations, a method of assembling a rotor assembly configured to rotate relative to a stator to drive a rotor shaft and at least one drive wheel of the electric vehicle is provided. The method includes: providing a rotor stack, a rotor shaft, a first end plate arranged at a first end of the rotor stack, a second end plate arranged at a second end of the rotor stack, and a rod assembly including a plurality of rods integrally formed with the first end plate; and inserting the plurality of rods through passages in the rotor stack and extending distal ends of the rods through a plurality of complementary passages defined in the second plate, wherein the rods each define notches at distal ends that locate at the plurality of complementary passages, wherein the distal ends of the rods are pressed into the plurality of complementary passages.

In other examples of the method, inserting the plurality of rods through passages comprises inserting a distal tip of a respective rod causing a the distal tip to deform inward upon passing through the respective passage and subsequently releasing outward after passing through the passage and aligning with a notch defined in the second plate.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings references therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a schematic illustration of an example electric vehicle drivetrain having an electric machine that incorporates a tie-rod configuration in accordance with one prior art example;

FIG. 2 is a front perspective view of the electric machine shown in FIG. 1;

FIG. 3 is an exploded view of the electric machine of FIG. 2 illustrating the tie-rod configuration according to prior art;

FIG. 4 is an exploded perspective view an electric machine that incorporates a rod configuration accordance with a first example of the present application;

FIG. 5A is a front perspective view of the integrally formed rod configuration and first end plate shown in FIG. 4 according to examples of the present application;

FIG. 5B is an end view of a second end plate shown in FIG. 4 according to examples of the present application;

FIG. 5C is a perspective view of the second end plate shown in FIG. 5B;

FIG. 6 is a front view of a rod and first end plate of FIG. 5A illustrating a notch for connecting to the second end plate according to examples of the present disclosure;

FIG. 7 is an exploded perspective view an electric machine that incorporates a rod configuration accordance with a second example of the present application; and

FIG. 8 is a front view of a rod constructed in accordance to a second example of the present disclosure and having notches defined at opposite ends for connecting to respective end plates.

### DETAILED DESCRIPTION

As noted above, tie-rods are typically steel rods that are threaded and pass through complementary holes in the rotor structure and secured with nuts and washers. The tie-rods provide may benefits to the rotor assembly including: structural integrity, reduced stresses and simplified assembly and maintenance process. Tie-rods however can introduce additional complexity and potential points of failure in the rotor structure. While tie-rods can provide mechanical support and help maintain the alignment of components, they can also create stress concentrations at the points where they are attached. This can lead to an increased risk of fatigue failure, especially if the tie-rods are not properly designed or installed. Tie rods can further add weight to the rotor assembly, which can negatively impact the overall efficiency and performance of the electric machine. The additional weight can also increase inertia, reduce acceleration capabilities, and potentially lead to increased energy consumption.

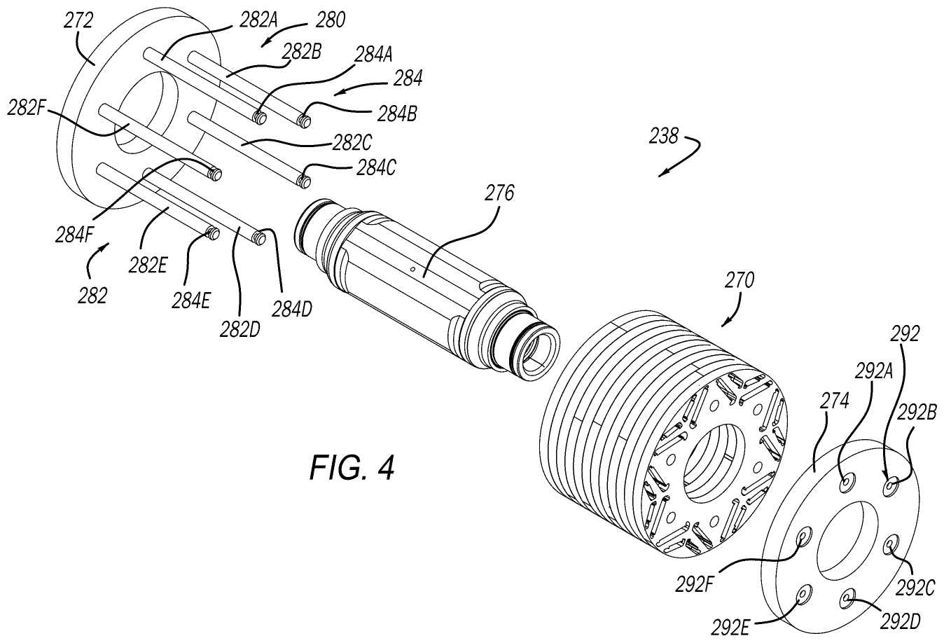

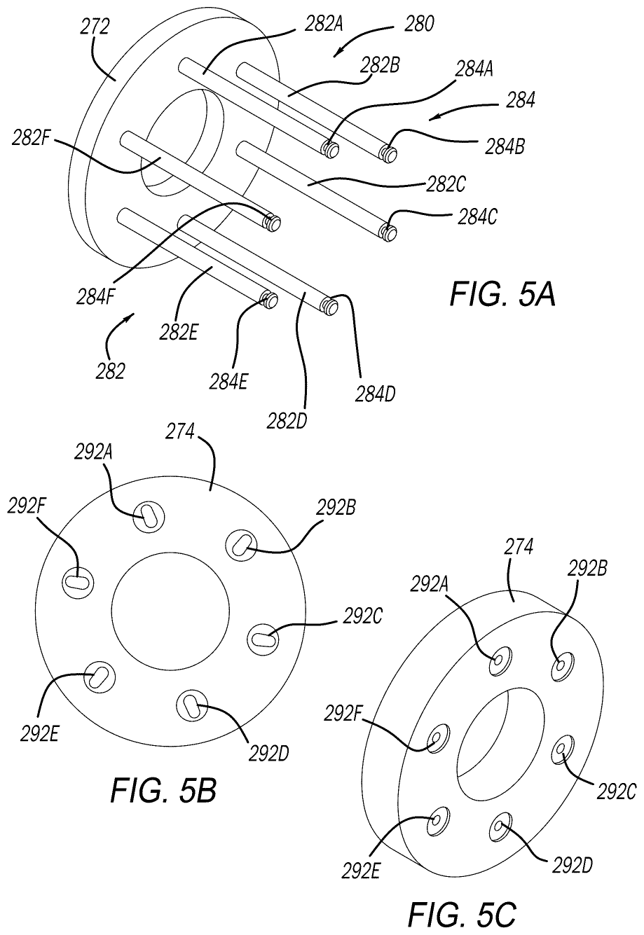

According to the principles of the present application, a new and improved design and manufacturing method for rotor assemblies with rods is provided. In a first example (FIGS. 4-6), the rods and the end-plate are formed on the same material. The rods are integrally formed with a first end-plate as a single component. The second end-plate is pressed and clipped onto the rod ends. The integration of the rods with the end-plate not only simplifies the assembly process but also ensures more robust and seamless connection between the components, providing a more efficient and durable rotor assembly. In addition, the clipping of the second end-plate removes the need for multiple nuts used to tighten the rotor assembly together.

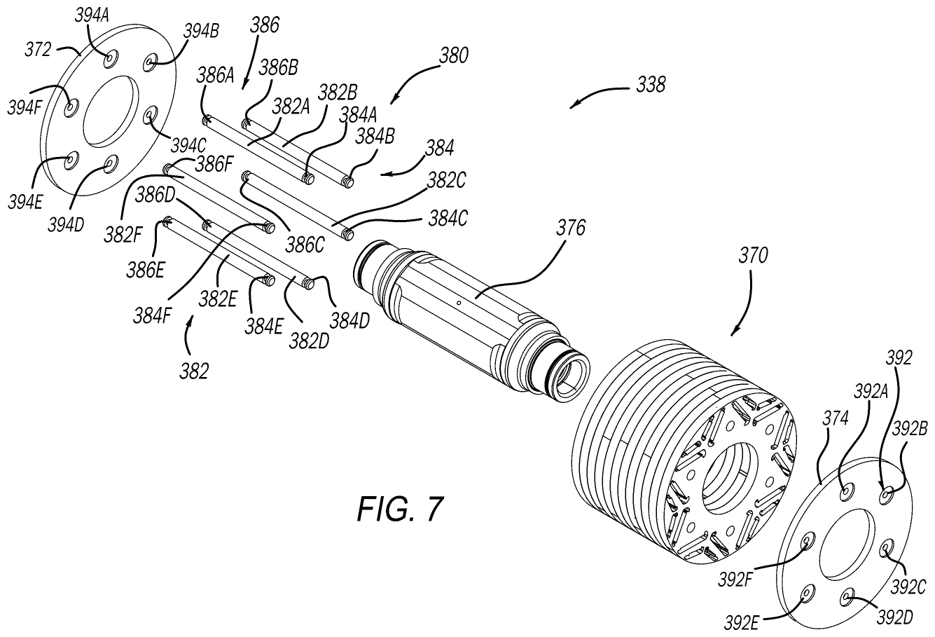

In a second example (FIGS. 7-8), the rods and the end-plate are formed of different materials. Two end-plates are clipped to the rods on both ends. The selection of either the first or second example depends upon factors such as, but not limited to, the electric machine size and power, the clipping force needed to tighten the rotor lamination stacks, and the electric machine operating and boundary conditions.

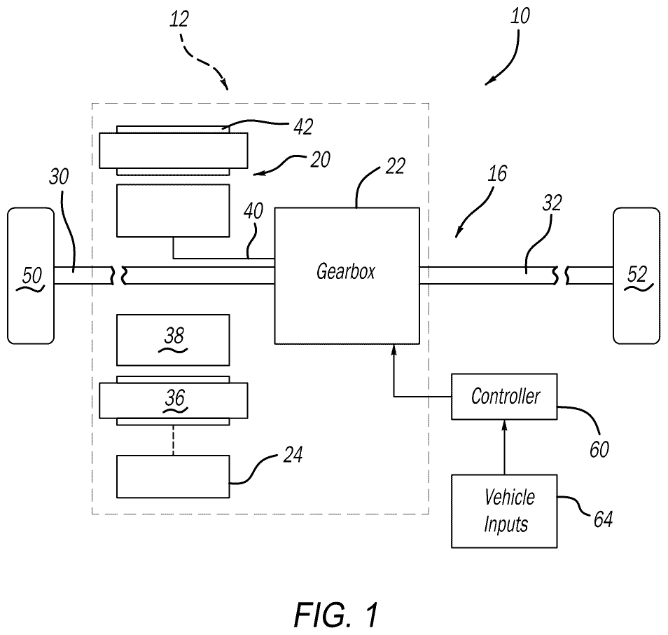

With initial reference to FIG. 1, a vehicle 10 is partially shown in accordance with the principles of the present disclosure. In the example embodiment, vehicle 10 includes an electric drive module (EDM) 12 configured to generate and transfer drive torque to a driveline 16 for vehicle propulsion. The EDM 12 generally includes one or more electric drive units or machines 20 (e.g., electric traction machines), a gearbox assembly 22, and power electronics including a power inverter module (PIM) 24. The electric machine 20 is selectively connectable via the PIM 24 to a high voltage battery system (not shown) for powering the electric machine 20. The gearbox assembly 22 is configured to transfer the generated drive torque to the driveline 16, including a first or left axle shaft 30 configured to drive a left wheel 50 and a second or right axle shaft 32 configured to drive a right wheel 52. In the example shown, the EDM 12 is configured for use on a rear axle of a two-wheel drive vehicle. It is appreciated however that the EDM 12 can be alternatively configured for use on a front axle of a two-wheel drive vehicle.

In other examples an EDM 12 can be provided on both of the front and rear axles for a four-wheel drive or all-wheel drive driveline vehicle. In the example embodiment, the electric machine 20 generally includes a stator 36, a rotor assembly 38 and a rotor output shaft 40. It will be appreciated that while the exemplary vehicle 10 is configured as an electric vehicle, the electric machine 20 can be suitable for use with other vehicle configurations that have electric machines 20 including those that also employ other supplemental drive sources (e.g., hybrid vehicles that also include internal combustion engines, etc.).

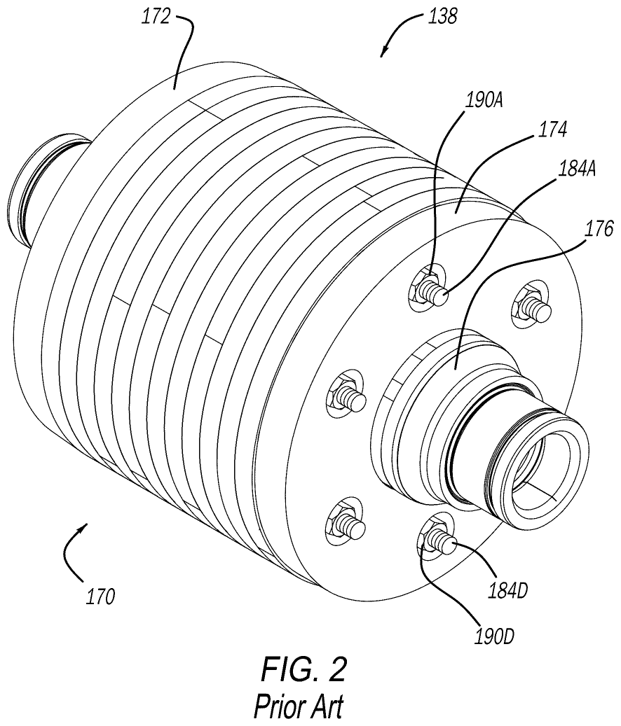

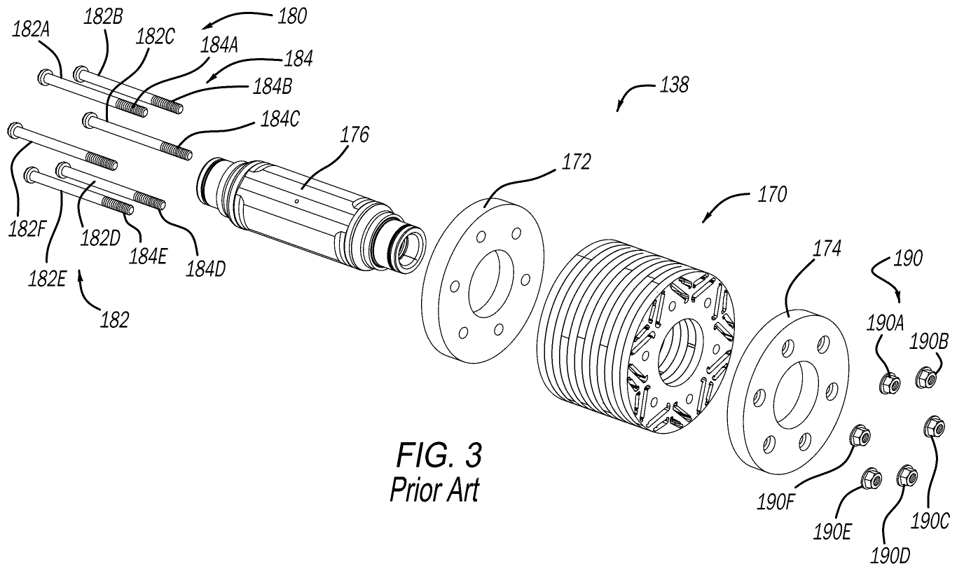

With additional reference now to FIGS. 2-3, a rotor assembly 138 constructed in accordance to one prior art example will be described. The rotor assembly 138 generally comprises rotor stacks 170, a first end plate 172, a second end plate 174, a shaft 176 and a tie rod assembly 180. The tie rod assembly 180 generally comprise a plurality of tie rods, collectively identified at 182, and individually identified at 182A-182F. The tie rods 182 have threaded distal ends, collectively identified at 184 and individually identified at 184A-184F. The threaded distal ends are configured to receive nuts, collectively identified at 190 and individually identified at 190A-190F.

Turning now to FIGS. 4-6, rotor assembly 238 that incorporates a rod assembly configuration 280 in accordance with a first example of the present application will be described. The rotor assembly 238 generally comprises rotor stacks 270, a first end plate 272, a second end plate 274, a shaft 276 and a rod assembly 280. The rod assembly 280 generally comprise a plurality of tie rods, collectively identified at 282, and individually identified at 282A-282F.

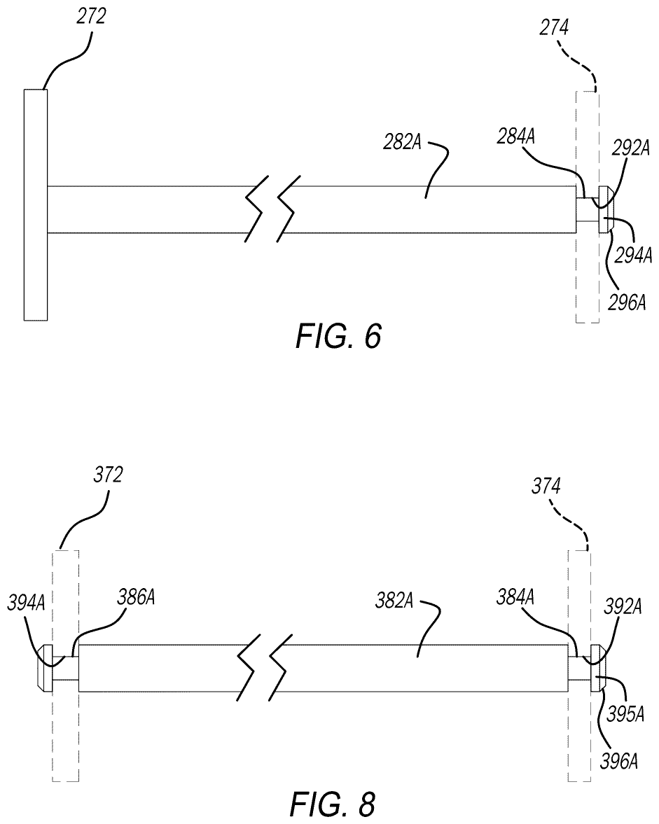

The rod assembly 280 is integrally formed with the first end plate 272. In this first example, the rod assembly 280 is formed of the same material as the first end plate 272. The rods 282 have notches at distal ends, collectively identified at 284 and individually identified at 284A-284F. The second end plate 274 defines a plurality of passages, collectively defined at 292 and individually defined at 292A-292F. In examples, the geometry of the passages 292 is complementary to the respective notches 284. The second end plate 274 can be pressed and clipped relative to the rods 282. As shown in FIG. 6, each rod 282A includes a distal tip 294A having a chamfered surface 296A. Insertion of the distal end of the rod 282A into the passage 292A will cause the distal tip 294A to deflect (deform) inward upon passing through the passage 292A and subsequently release outward after passing through the passage 292A and aligning with the notch 284A resulting in a clipping action.

The removal of the nuts in the rod assembly 280 will reduce the overall manufacturing and assembly cost (less assembled parts), and therefore, reduce the cost. The integration of the rods 282 with the end-plate 282 not only simplifies the assembly process but also ensures more robust and seamless connection between the components, providing more efficient and durable rotor assembly 238.

Turning now to FIGS. 7 and 8, rotor assembly 338 that incorporates a rod assembly configuration 380 in accordance with a second example of the present application will be described. The rotor assembly 338 generally comprises rotor stacks 370, a first end plate 372, a second end plate 374, a shaft 376 and a rod assembly 380.

The rod assembly 380 generally comprise a plurality of tie rods, collectively identified at 382, and individually identified at 382A-382F. The rod assembly 380 is not integrally formed with the first end plate 372 as shown in the first example (FIGS. 4-6). In this second example, the rod assembly 380 can be formed of the distinct material as the first end plate 372. The rods 382 have first notches at first distal ends, collectively identified at 384 and individually identified at 384A-384F. The second end plate 374 defines a plurality of passages, collectively defined at 392 and individually defined at 392A-392F. As shown in FIG. 8, each rod 382A includes a first distal tip 395A having a chamfered surface 396A. Insertion of the distal end of the rod 382A into the passage 392A will cause the distal tip 394A to deflect (deform) inward upon passing through the passage 392A and subsequently release outward after passing through the passage 392A and aligning with the notch 384A resulting in a clipping action. It will be appreciated that the same relationship exists when inserting the opposite end of the rod 382A into the first plate 372.

The two end-plate configuration (FIGS. 7, 8) is simpler and less complicated compared to the prior art configuration. Further, it does not require large thickness. As a result, overall mass and manufacturing cost are reduced. Overall efficiency of the rotor assembly 338 is improved.

In examples, the geometry of the passages 392 is complementary to the respective first notches 384. The rods 382 also have second notches at second distal ends, collectively identified at 386 and individually identified at 386A-386F. The first end plate 374 defines a plurality of passages, collectively defined at 394 and individually defined at 394A-394F. In examples, the geometry of the passages 394 is complementary to the respective second notches 386.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

What is claimed is:

1. An electric machine for powering an electric vehicle, the electric machine comprising:
a rotor assembly configured to rotate relative to a stator, the rotor assembly comprising:
a rotor stack;
a rotor shaft;
a first end plate arranged at a first end of the rotor stack;
a second end plate arranged at a second end of the rotor stack; and
a rod assembly including a plurality of rods integrally formed with the first end plate, the plurality of rods extending through passages in the rotor stack and extending through a plurality of complementary passages defined in the second end plate.

2. The electric machine of claim 1, wherein rods of the plurality of rods each define notches at distal ends that locate at the plurality of complementary passages in the second end plate.

3. The electric machine of claim 2, wherein the plurality of rods are pressed into the plurality of complementary passages in the second end plate.

4. The electric machine of claim 1, wherein the first end plate and the rod assembly are formed of a common material.

5. The electric machine of claim 2, wherein the passages of the plurality of complementary passages defined in the second end plate define one of circular and elongated holes.

6. The electric machine of claim 5, wherein the respective notches of the plurality of rods locate at the one of circular and elongated holes.

7. An electric machine for powering an electric vehicle, the electric machine comprising:
a rotor assembly configured to rotate relative to a stator, the rotor assembly comprising:
a rotor stack;
a rotor shaft;
a first end plate arranged at a first end of the rotor stack, the first end plate defining a plurality of first passages;
a second end plate arranged at a second end of the rotor stack, the second end plate defining a plurality of second passages; and
a rod assembly including a plurality of rods extending through passages in the rotor stack and having first ends extending through a plurality of first complementary passages defined in the first end plate and second ends extending through a plurality of second complementary passages defined in the second end plate.

8. The electric machine of claim 7, wherein rods of the plurality of rods each define first notches at first distal ends that locate at the plurality of first passages in the first end plate.

9. The electric machine of claim 8, wherein rods of the plurality of rods each define second notches at second distal ends that locate at the plurality of second passages in the second end plate.

10. The electric machine of claim 9, wherein the plurality of rods are pressed into the plurality of first passages in the first end plate.

11. The electric machine of claim 10, wherein the plurality of rods are pressed into the plurality of second passages in the second end plate.

12. The electric machine of claim 7, wherein the first end plate and the rod assembly are formed of distinct materials.

13. The electric machine of claim 8, wherein the passages of the plurality of complementary passages defined in the first end plate define one of circular and elongated holes.

14. The electric machine of claim 13, wherein the respective notches of the plurality of rods locate at one of the circular and elongated holes.

15. A method of assembling a rotor assembly configured to rotate relative to a stator, the method comprising:
providing a rotor stack, a rotor shaft, a first end plate arranged at a first end of the rotor stack, a second end plate arranged at a second end of the rotor stack, and a rod assembly including a plurality of rods integrally formed with the first end plate; and
inserting the plurality of rods through passages in the rotor stack and extending distal ends of the rods through a plurality of complementary passages defined in the second plate, wherein the rods each define notches at distal ends that locate at the plurality of complementary passages, wherein the distal ends of the rods are pressed into the plurality of complementary passages.

16. The method of claim 15, wherein inserting the plurality of rods through passages comprises inserting a distal tip of a respective rod causing a the distal tip to deform inward upon passing through the respective passage and subsequently releasing outward after passing through the passage and aligning with a notch defined in the second plate.
